(19) United States
(12) Patent Application Publication
(10) Pub. No.: US 2002/0031581 A1
(43) Pub. Date: Mar. 14, 2002

(54) Food grade products from fruit and vegetable by-products

(76) Inventor: John L. Baker IV, Naples, FL (US)

Correspondence Address: HAHN LOESER & PARKS, LLP, TWIN OAKS ESTATE, 1225 W. MARKET STREET, AKRON, OH, 44313, US

(21) Appl. No.: 09/974,751

(22) Filed: Oct. 10, 2001

Related U.S. Application Data
(63) Continuation of application No. 09/366,457, filed on Aug. 3, 1999, now abandoned.

(51) Int. Cl. A23L 1/212

(52) U.S. Cl. 426/431; 426/615

(57) ABSTRACT

A processing system and methods are provided which allow useful byproducts to be extracted and organic and or plant materials reduced to a food grade or other useful product.

### TECHNICAL FIELD

The present invention is directed to the processing of fruit and vegetable byproducts to produce food grade products.

### BACKGROUND OF THE INVENTION

Many fruits and vegetables are de-juiced to produce fruit and vegetable juices. After dejuicing, the remaining dejuiced plant material from the fruits or vegetables, which may include peel, pulp, rag and seeds for example, contain potentially useful substances that can be extracted from these materials. In the case of oranges and a variety of other fruits and vegetables, the material remaining after juicing contains essential oils and essences, being the odor and/or flavor components of the peel along with various sugars, pectin, and the rag and pulp solid materials which remain.

The essential oils are desirably separated from the de-juiced organic material, and can be used as flavorings, fragrances, and solvents. The remaining solid material has been typically used after processing as an animal feed. For example, prior art processing techniques with respect to orange peel processing use an orange peel shaver through which oranges are passed to remove at least a portion of the peel through extraction of juice from the oranges. Peel removed prior to extraction may be provided to a peel oil recovery system in an attempt to extract the essential oil contained therein. The remaining orange is forwarded to juice extraction equipment, and the remaining peel, rag and pulp is then sent through a hammer mill. The hammer mill causes the remaining peel and rag materials to be broken into relatively large portions which are then passed to mixing screws where an amount of calcium oxide is introduced for de-watering of the materials. At this point of processing the orange peel material, the peel moisture is approximately 80-85% water content, with the addition of calcium oxide designed to reduce the water content to some degree. From the mixing screws, the orange peel and addition of calcium oxide is passed to a series of large vertical presses to attempt to press out some of the water remaining in the peel. The vertical presses are also designed to produce presses liquor via an evaporation process as a byproduct. The mixture is then forwarded to additional mixing screws where calcium oxide is again added for de-watering with the pressed peel material containing approximately 68% water moisture at this state of processing. The addition of calcium oxide and mixing with the peel material in the mixing screws is performed at ambient temperature to reduce the water content of the peel material to the approximate 68% level. From the mixing screws, the material then proceeds to a gas fired rotary dryer, through which the material is passed for a dwell time of approximately 40 minutes. Within the gas fired rotary dryer, the water content of the peel material is reduced to approximately 12% moisture, and this material can now be handled in a pelletizing process to produce pellets usable as a feed for cattle or other animals. The pellets are characterized as a non-food grade material, due to the addition of calcium oxide, making it unsuitable for human consumption. Other various attempts have been made to process orange peel or like materials, being byproducts of a juicing or other extraction process in order to make use of the de-juiced plant material remaining from the juicing or extraction process. Such attempts have included use of a non-aqueous solvent to facilitate extraction of certain materials from orange peels without introducing calcium oxide as an example. Although such attempts recognize the desirability of processing plant material to form useful products for human consumption, none of the prior art techniques provide desired extraction of the useful materials from the plant material in an effective and cost justified basis.

One significant problem experienced with the processing of de-juiced orange peels or other similar materials, is the loss of essential oils and other components of the orange peel to the atmosphere and to waste liquid streams released to the environment. Some of these components such as the essential oil d-limonene are recognized as pollutants and their release to the environment is restricted; see e.g. U.S. Pat. No. 3,966,984. These volatile organic compounds (v.o.c's) must then be scrubbed or cleaned from the waste stream, requiring sophisticated equipment. Alternatively, a processing facility may be permitted to release an amount of v.o.c. pollutants into the atmosphere, but such permits carry a very high price tag associated therewith. The undesirable release of pollutants or the added cost associated with removing such contaminants from the waste streams have made the prior art attempts at processing of these plant materials unacceptable or too costly. The v.o.c's in the case of orange peel processing result from the essential oils which remain in the peel material which are released upon drying thereof within the gas fired rotary dryer. Therefore, in addition to the potential release of noxious compounds in the process waste streams, the value of the essential oils for use in other products is also lost. Similarly, the use of additives or solvents in a process also carries a high cost which can be prohibitive, leading to a resultant product from which the costs of production cannot be recovered. It would therefore be desirable to have a process that produces food grade materials from plant materials without the use of lime, non-aqueous solvents, digestion agents, or other chemical additives, and that significantly reduces the emission of polluting materials to the environment.

### SUMMARY OF THE INVENTION

Based upon the foregoing, the present invention is therefore directed to a processing system and methods which allow useful byproducts to be extracted and organic and or plant materials reduced to a food grade or other useful product.

It is therefore an object of the present invention to provide a process for the recovery of useful products from organic or plant materials.

It is another object of the present invention to provide a system and process for the recovery of useful products from organic material wherein the emission of polluting materials to the environment is reduced.

In one aspect of the present invention there is provided a system and process for the recovery of useful products from organic or plant material, comprising the steps of obtaining organic or plant material comprising at least one extractable substance selected from the group consisting of sugars and oils. The organic material is comminuted to produce comminuted material, to a particle size that facilitates extraction of oils, sugars, etc. Thereafter, the step of extracting a substantial amount of the at least one extractable substance from the comminuted material is performed, in the preferred embodiment by contacting the material with at least a heated liquid. This produces a slurry of comminuted organic material and an extract comprising liquid and an amount of the at least one extractable substance. The slurry is filtered to remove the extract to produce a filtrate comprising the liquid and the at least one extractable substance. The at least one extractable substance is then separated from the liquid for use.

In another aspect of the invention, a system in process for the recovery of useful products from organic or plant material comprises obtaining organic or plant material including at least one extractable substance selected from the group consisting of sugars and oils. The plant material is comminuted, and a substantial amount of the at least one extractable substance is removed from the comminuted material, leaving a solids material. Thereafter, the solids material is dried without the addition of chemical agents and post-processed into a final “food grade” product. As an alternate embodiment of the system in process according to the invention, the plant material may be de-juiced to a substantial degree prior to further processing, such as for products including oranges or other fruits and vegetables or other crops having a substantial juice content. Any peel may have to go through comminution 2-3 times to press to remove oils, and sugars. The material left is inert and may not need scrubber.

### BRIEF DESCRIPTION OF THE DRAWINGS

The features and advantages of the present invention will be better understood with reference to the following detailed description and appended claims, in conjunction with the drawings, wherein:

FIG. 1 is a block diagram of a first embodiment of the system in process for the recovery of useful products from plant materials according to the invention.

FIG. 2 is a block diagram showing another embodiment of the system process for the recovery of useful products from plant materials according to the invention.

FIG. 3 is schematic representation of an embodiment of the invention for use with the processing of oranges and/or orange peels, being representative of the invention.

### DETAILED DESCRIPTION OF THE INVENTION

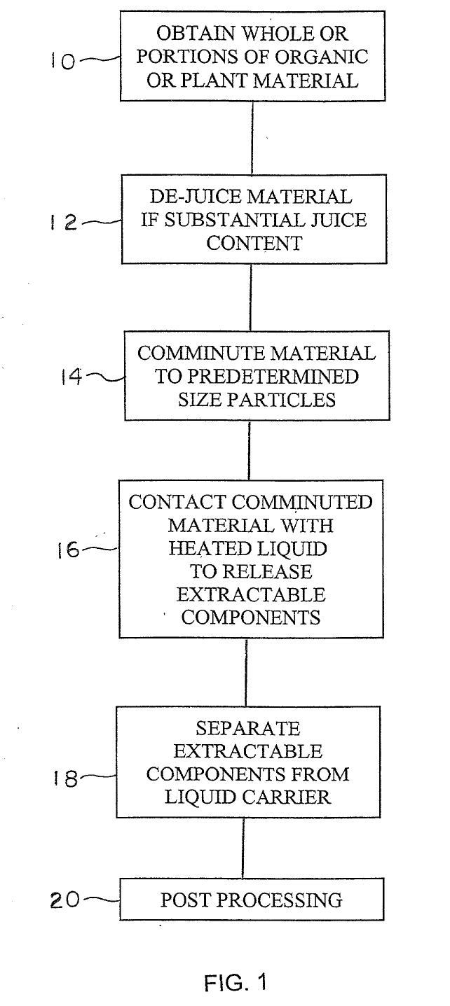

Turning now the figures, FIG. 1 relates to a first embodiment of the invention, for use in extraction of valuable materials from an organic material such as fruits, vegetables, fish and other food products, as well as plant materials such as sugar cane and fibrous plant materials. Although the invention is described in part in relation to processing of certain types of materials, the preferred embodiments of the invention are only representative, and various systems and methods contemplated by the invention are not limited thereby. Thus, although the invention may be described in relation to processing of plant materials such as fruits or vegetables, or their constituent parts, the system and methods according to the invention may also be used for processing materials the variety of materials mentioned herein as well as similar materials as will become clear.

In FIG. 1, the system and method according to one aspect of the invention is shown to include at 10 the step of merely providing or obtaining whole or portions of organic or plant material for processing. As will become evident, for use with some types of products, the invention may be used as a post-processing step in order to yield additional useful byproducts from a primary processing system. For example, oranges and other fruits are typically processed to remove the juice content therefrom for consumption by people. Thus, the system and methods according to the invention may be used for processing of de-juiced food or plant materials. Alternatively, the invention may also be used for processing of whole food or plant materials, if desired, and similar extraction of juice content within a material may be performed as a part of the invention. The material thus may be de-juiced if there is substantial juice content at step 12, as such juice content may be valuable and worthy of extraction. The material is then comminuted at 14 to predetermined size particles. In accordance with the invention, the reduction of particle size is designed to substantially increase the surface area of the organic material, to allow release of extractable components within the organic material. It has been found that particle sizes of 1/16 of an inch or smaller with most organic materials allows proper extraction of these components in later processing systems and steps. More preferably, but dependent upon the type of material being processed, a particle size range between 10 to 200 mesh provides surface area characteristics which, together with other system parameters, enhance extractability of the sugars, oils or like substances. Thereafter, the comminuted material is contacted with a heated liquid to release the extractable components therefrom at 16. If desired, comminuted materials may be pre-heated prior to or in conjunction with addition of a liquid carrier by injection of steam or other high temperature source. Further, the liquid carrier at step 16 may be preheated, or the slurry thereafter heated in the preferred embodiments, to facilitate release of the extractable components from the material. It is to be understood that the liquid carrier is of a character that processing of the material is performed at “food grade” standards. For example, the liquid carrier may be water which is easily handled in existing processing environments, or other similar materials which are food grade compatible. It should also be understood, that the liquid carrier is preferably of a character which will not chemically interact with the material, but instead facilitates extraction of components such as oils, sugars, and the like from the comminuted materials due to the increased surface area exposing such materials to the liquid carrier. It should also be understood that the liquid carrier may be integrated into the organic material, such that no additional liquid is necessary for processing. For example, in conventional food processing systems for processing of materials such as fish, the fish are generally filleted for subsequent consumption by the consumer. The filleting process leaves residual fish parts which clearly have nutritional content, but are aesthetically unusable. The present invention may be used for processing of such materials, or even whole fish, wherein the liquid content of the material may be sufficient to produce the desired results according to the invention. Thus, fish oils could be removed from the materials, and as will be described hereafter, the remaining materials may be also of use due to the food grade processing standards of the invention.

After release of the extractable components from the comminuted materials, the liquid emulsion of the liquid carrier and extracted components is subjected to a separating step at 18 to separate the extractable components from the liquid carrier. Once these components are extracted, they may then be subjected to post-processing steps of a suitable nature to reduce the components to a usable commodity. Such usable products may comprise sugars, essential oils, essences, bioflavanoids or other extractable components.

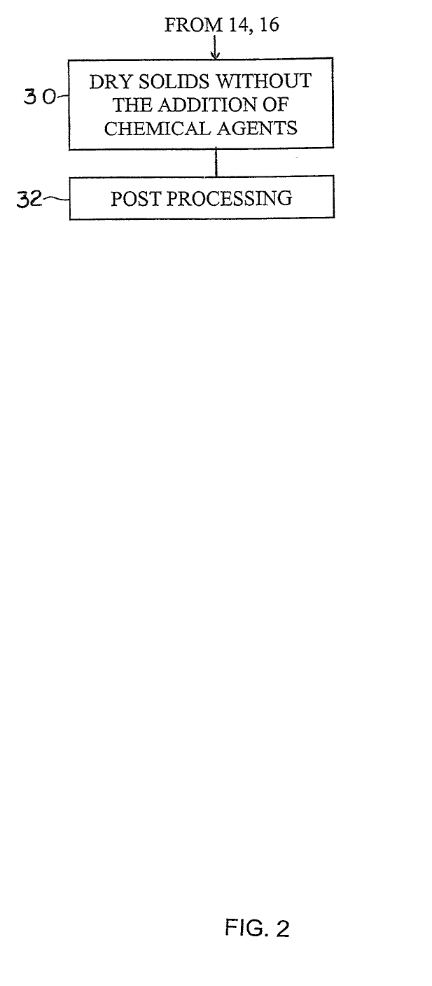

In an alternate embodiment of the invention, as shown in FIG. 2, various steps of the system as shown in FIG. 1, including 10, 12, 14 and 16 are used to release the extractable components from the organic materials, resulting in a solids residual material. Thus, after step 16 in which extractable components are released from the comminuted material, step 30 of FIG. 2 may then be implemented in the following preferred embodiment. At the same time, it should be recognized that some materials may not have valuable components to be extracted such as oils, sugars, or essences, and in such case, the comminuted material from step 14 may then supply material at step 30 in this embodiment. It shall also be evident that this embodiment of the invention may be used in conjunction with the system as shown in FIG. 1 to result in first and second product streams comprising the extractable components and food grade solids. The solids comprising at least a portion of the comminuted material is subjected to drying without the addition of chemical agents so as to maintain the food grade character of the material. Typically organic materials will contain a significant amount of water content, and the step 30 of drying the solids materials is designed to reduce the water content in a fast, cost effective manner. The dried solids materials may then be forwarded for post-processing at 32. As the dried solids material has previously been comminuted to very small size particles, the material may simply be in a usable form, such as for a filler in other food products. As the dried solids material is “food grade”, it may now be used in a variety of ways not previously possible in the prior art techniques, such applications being of significant increased value over use of the materials in animal feed as an example. To give an idea of such an application, orange peel and other residual components from a de-juicing process may be processed in the system and methods according to the invention to yield a food grade particulate which may be further processed into a flour or additive for use in baked food products. The nutritional character of the organic material subjected to processing according to the invention is maintained, and provides another source for food additives in a variety of other applications. As previously described, fish may also be processed according to the invention to extract fish oils or other components, with the residual solids materials being subjected to the process of FIG. 2 to result in a product which could be used to form fish puree food products.

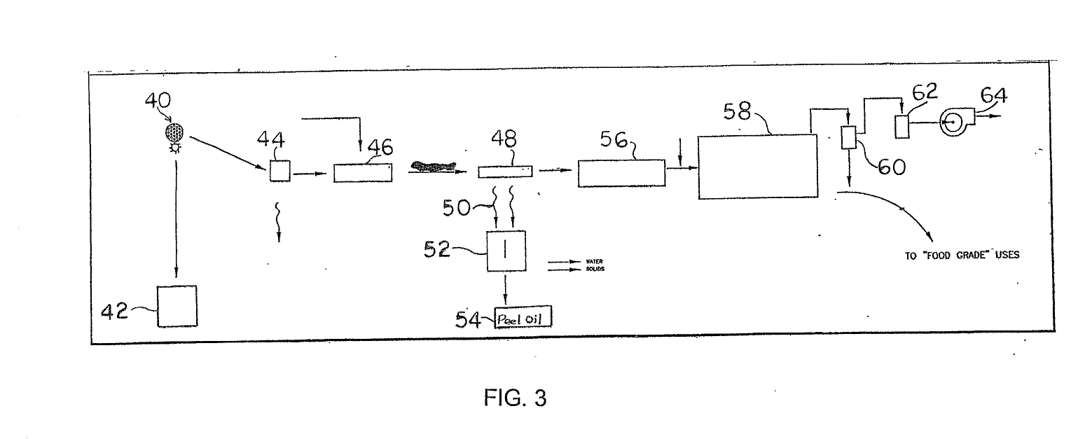

Turning to FIG. 3, this shows a preferred system and method for processing of orange peel or other citrus products and residual materials from a de-juicing or peel oil recovery system process. It should be recognized that in processing of such material streams, a large volume of material must be handled in an efficient and cost-effective manner. The processing system and methods described with reference to peel processing are again representative, and processing of other organic materials may vary subject to differences in those materials or other factors without departing from the scope of the invention. As an example of a peel processing system, whole oranges are subjected to orange peel shavers at 40 in an attempt to remove a portion of the peel oil via a peel oil recovery system 42. Such systems have been implemented for example in certain commercial orange processing plants in the United States. Although the peel oil recovery system does provide for recovery of an amount of peel oil from the oranges being processed, a significant amount of peel oil remains. The present invention may also eliminate the present peel oil recovery systems, with peel oil being extracted during processing as will be described. Thereafter, the oranges are forwarded to an extractor 44 which extracts single strength juice for processing into orange juice or concentrate, or is forwarded to evaporators for production of purified sugar syrup or other products. In this embodiment as shown, in which steps 40-44 are typically found in a conventional orange processing plant, the remaining steps may then be performed in addition to these steps as already performed in such environments. Alternatively, the steps 40-44 may be dispensed with and whole oranges processed according to the invention to not only extract the juice from the orange product, but also to extract and use the remaining constituents of the orange product. Thus, as shown in FIG. 3, steps 40-42 may be dispensed with, and whole or portions of oranges fed to the extractor 44 for juice extraction. Alternatively, another type of extraction process may be used, where an extraction of juice may be performed simultaneously along with comminution of the oranges at 46. In the preferred embodiment, the comminuted system 46 comprises a pulper system, such as the equipment produced by Bolton-Emerson America's, Inc. under the name Tornado Pulper. This equipment performs comminution of the orange material to the desired particle size range, with the particle sizes being 1/16 of an inch or smaller, and preferably reducing the material to particle sizes in the range between 40 to -60 mesh. In the preferred pulper, high temperature water is added to the pulper to form a slurry with the orange material which is subjected to a torroidal flow pattern through a rotor and stator assembly to be forced at high velocity through an extraction zone and recirculation line for pulping of the material. The preferred equipment must be food grade character such that processing of the orange material is performed without introduction of unacceptable materials for subsequent human consumption. The comminution equipment may thus be of a different character to reduce the orange material to the desired size range, and preferably forms a product stream in which the orange material has been reduced uniformly to the desired size. Other suitable equipment may be preferred for other materials, such as milling or shredding equipment for such materials as sugar cane or other fibrous plant materials.

A pulper of this type may be supplied with a large volume of orange material for processing, making it efficient and cost effective in handling the large volumes of such material expected in such an environment. The temperature of the water added in the preferred embodiment to the pulper 46 is approximately 100-150° F., and facilitates release of extractable materials from the orange material, such as essential oils and sugars. These materials are washed out of the solids material or pectin of the orange, and released into the hot water.

It may also be desirable to apply a pre-blast of steam to increase the heat or temperature thus facilitating the extraction of the oils. For example, a steam injection could take place between the pulper 46 and the presses 48. The smaller the particle fragmentation and the hotter the material, the better removal of the oils occurs.

In the orange processing system, the comminuted orange material is then fed to one or more screw presses 48 which are also designed to be food grade acceptable. Suitable screw presses 48 are manufactured by Hosakawa Bepex Corporation or Automatic Machinery as examples.

In the orange material, the extracted substances include d-limonene and other essential oils, sugars, pectin, cellulose, and other peel solids. The amount of oil in the filtrate typically is about 12 to 14 percent by weight. This filtrate product is then further processed to isolate desirable products such as the oils, sugars, and pectin.

The amount of hot water in contact with the comminuted material is preferably about 0.1 to about 0.5 pounds of water per pound of comminuted plant material, more preferably about 0.15 to about 0.4 pounds of water per pound of comminuted plant material, and most preferably about 0.2 to about 0.33 pounds of water per pound of comminuted plant material. The most preferable range of water amounts allows adequate agitation of the solid/liquid mixture in the pulper and to facilitate extraction. The use of water within the preferred range also reduces the amount of water that must be subsequently separated from the extracted solids by filtration and drying. In addition, the amount of water that must be removed from the filtrate to concentrate the filtrate to a useable liquor is also reduced. The liquid temperature is preferably at least 130° F., more preferably 150° F. The temperature should not be greater than the boiling point of the liquid. The contact residence time during which the comminuted plant material is in contact with the water is preferably at least 5 to about 8 minutes.

Of further assistance to the extraction process is agitation of the water and comminuted material with a high shear rate that continuously regenerates the contact interface between the comminuted solid-particles and the hot water, such that steep concentration profiles of the extractable substances is maintained across the solid/liquid interface. The shear rate should be high enough to maintain steep concentration profiles but not so high as to unnecessarily waste energy input to the agitation mechanism.

As previously mentioned, the temperature of the slurry forwarded to the screw presses 48 is raised to facilitate release of extractable materials from the orange material. The solubility of oils and sugars is much greater in a higher temperature water, such that these compounds are mechanically released into the slurry and extracted via the screw presses 48. The screw presses 48 produce an oil/water emulsion at 50, which is directed to an extraction system 52 which in the preferred embodiment comprises one or more decanter centrifuge separators which separate the oil content of the emulsion to produce a peel oil stream 54 as well as water and solids streams. The amount of pressure applied by the presses 48 also assists in the extraction of oils, sugars and other potential by-products. The product remaining is a byproduct from the screw presses 48 is somewhat compressed using this type of equipment, and may then be fed to a crumblizer 56 which will separate the compressed material back into a particulate material. If a crumblizer 56 is used in processing, the equipment should again be food grade compatible as desired. The peel particles from crumblizer 56 at this point in the processing system are still hot, preferably in the range of 150-250° F., and still have a substantial amount of moisture content, which has been measured at between 40-80% by weight. To reduce the moisture content, the peel particles are directed in the preferred embodiment to a fluidized bed gas fired dryer 58, such as produced by Hosakawa Bepex Corporation or by Wolverine Corporation under the name Jet Zone™. This type of equipment is again food grade compatible, and the peel particles will travel therethrough with a dwell time of between four to five minutes in the preferred embodiment to quickly reduce the moisture content of the particles to approximately 5-20%. Such material stream will be food grade condition for use in a variety of food grade applications. In addition, the output stream of the fluidized bed dryer 58 may be fed to a product recovery apparatus, also being food grade compatible, for recovery of any very small particles which have been caught in the disposal air stream of the dryer 58. The product recovery apparatus 60 may be a screening system, such as produced by Product Engineered Systems, Inc. under U.S. Pat. No. 5,573,563. Any product recovered by apparatus 60 is returned to the food grade product stream. As merely an example, the processing system in FIG. 3 can produce almost 34,000 pounds per hour of very small peel crumbs which are easily handled and packaged for shipment.

As an alternative, it may be possible to eliminate the use of an extractor 44 by utilization of a pulper 46 to also remove the juice content of whole oranges or other organic material. If whole oranges are input into pulper 46, the juice content of the oranges will be released and will become part of the slurry from the pulper 46 that is directed to the presses 48. The liquid stream produced from press 48 will therefore include juice content as well as the oils, sugars or other byproducts extracted from the peel or solids materials. As the presence of such byproducts is undesirable in the juice content of the liquid stream for producing juice products, the liquid stream may then be directed to a TASTE™ evaporator, such as produced by Gulf Machinery, Inc. or the like, for extraction of oils, essences, sugars or other byproducts for use, while producing a juice concentrate product similar to that produced using typical juice extraction equipment. Further, rag and seeds can be separated from the whole citrus material using Beloitte cleaners or other suitable equipment, thus isolating the peel material for pure oil extraction. Such cleaning of the organic material will allow production of a purer citrus peel material that will dry faster than whole peel material, and will produce a better product for flour making or other food grade uses. Seed and rag can be separated out using a similar apparatus, but having multi-stage operation to separate the rag for the cellulose market. The rag material is 100% cellulose, and removal of other materials allows this material to be isolated, while separating seed for the high nutrition citrus seed market.

As previously discussed, the removal of a large proportion of peel oil from the product in the processing system greatly reduces the v.o.c's which are produced upon drying of the peel material at 58. If the oil content of the material is not reduced a substantial degree, the v.o.c. emission from dryer 58 will require substantial cleaning under current environmental regulations to reduce such emissions. Presently, emissions of v.o.c's from orange processing plants is significant, and the present invention can greatly reduce the v.o.c. content of material to thereby reduce such emissions. To further insure an environmentally safe emission stream from dryer 58, a scrubber apparatus 62 may be used to further remove any v.o.c. content remaining in the air stream. The dryer exhaust fan 64 then discharge a clean waste stream to the atmosphere at greatly reduced costs. To further facilitate operation of the processing system, hot air from the dryer exhaust fan 64 may be recycled to the dryer 58 to reduce costs. Similarly, a clean water stream from the scrubber apparatus 62 may be recycled to the comminution equipment 46. If total extraction of oils and sugars or like materials can be performed with respect to the peel or other organic material, which is in general possible using the apparatus and processes of the invention, the remaining material is substantially inert, and will not result in the formation of v.o.c.'s. In this case, no scrubbing of the gases produced in the drying of this material will be necessary.

While the preferred embodiment of FIG. 3 is describing the invention using oranges as an exemplary plant material, the invention is not so limited. Other citrus fruits, including lemons, limes, grapefruits, tangelos, and tangerines can be processed using the systems and methods of the present invention. Other materials are also suitable, including but not limited to fruits such as apples, bananas, pears, peaches, grapes, pineapples, berries, and vegetables such as carrots, beets, and tomatoes, and other materials such as sugar cane, fibrous plants, fish, meats and other materials.

Such other materials may be comminuted at 46 by other suitable means if more efficient, such as by grinding, chopping, crushing, tearing, macerating, pulping, shredding, pulverizing, and shearing or other size reduction processes as are described in Perry's Chemical Engineers' Handbook, 7th ed. (McGraw-Hill 1997) (Hereinafter Perry's), Section 20, incorporated herein by reference.

To effect an extraction of a substantial amount of extractable substances from the comminuted oranges in the preferred embodiment, the comminuted material is maintained in intimate contact with hot water for a predetermined period of time. The extractable substances migrate from the comminuted material into the hot water phase. The time that the comminuted material is desirably in contact with the hot water will be characterized by a contact residence time, which will vary for the type of material processed. For a batch process, the contact residence time is approximately the batch time for the extraction device, and for a continuous process is the volumetric throughput rate divided by the fluid volume of the extraction device. While not wishing to be bound by any theory, extraction of the extractable substances may be effected by any of various thermodynamic and mass transfer processes including melting, desorption, dissolution, phase separation, volatilization, diffusion and convection. These extractable substances include various sugars including sucrose, dextrose, and levulose; d-limonene, and other essential oils from the oranges.

Various substances present in oranges are extractable using the methods of the present invention. Most if not all of the essential oils are non-water soluble at ambient temperatures of 50 to 90° F., but may be at least partially soluble or otherwise extractable with water at higher temperatures. In the embodiment of FIG. 3, no nonaqueous solvents or other chemical additives are required to aid in the extraction of the non-water soluble oils from the comminuted material. The combination of the high water temperature and high surface area of comminuted material effects extraction of sugars and oils from the material without the use of solvents or other additives; the use of a sufficient contact residence time and adequate agitation of the water/solid mixture allows a substantial amount of the oils, along with the water-soluble sugars, to be extracted. The reduction of the content of extractable substances in the comminuted material subsequent also facilitates handling of the solid comminuted material without subsequent release of these compounds. Further, the flavor of the solid residual material is not noticeably affected by residual oils, such as d-limonene in the oranges, and the amount of oils exhausted to the atmosphere and to waste water streams is low.

While comminution in the presence of water is preferred, it is not required. If water is not required, the removal of oil or other extractables may be performed by other suitable equipment other than as shown in this embodiment. Water as required in subsequent steps of the process can be added after comminution by a suitable method.

Further, although drying of the orange material is performed with a continuous fluidized bed dryer, drying can be accomplished in either batch or continuous mode using any of the various drying technologies known to those with skill in the art. Such drying technologies include rotary drying, tumble drying, tray drying, vacuum drying as well as fluid bed drying. Such methods include those described in Perry's, Sections 12 and 17, incorporated herein by reference.

While in accordance with the patent statutes, only the preferred process and method of the invention has been described in detail, it is to be understood that the invention is not to be limited to those teachings, but is to be covered by the scope of the appended claims.

What is claimed is:

1. A process for the recovery of useful products from organic material, comprising the steps of:
obtaining an organic material comprising at least one extractable substance selected from the group consisting of sugars and oils;
comminuting said material to produce comminuted material;
contacting said comminuted material with an amount of a liquid having a temperature high enough to effect extraction of said at least one extractable substance, wherein said contacting occurs for a contact residence time sufficient to extract a substantial amount of said at least one extractable substance from said comminuted material into said liquid; and
separating the liquid from the comminuted material and said at least one extractable substance from said liquid.

2. The process of claim 1, wherein said liquid comprises water.

3. The process of claim 1, wherein said contact residence time is at least 5 minutes.

4. The process of claim 1, wherein the amount of said liquid is from about 0.2 to about 0.33 pounds per pound of comminuted material.

5. The process of claim 1, wherein the amount of liquid is from about 0.1 to about 0.5 pounds per pound of comminuted material.

6. The process of claim 1, wherein the amount of liquid is from about 0.15 to about 0.4 pounds per pound of comminuted material.

7. The process of claim 1, wherein the liquid temperature is at least 130 F.

8. The process of claim 1, wherein the liquid temperature is at least 150 F.

9. The process of claim 1 wherein the material is an at least partially de-juiced plant material.

10. The process of claim 9, wherein said separating step comprises the steps of:
filtering a substantial amount of said liquid from said comminuted plant material to produce a filtrate comprising said liquid and said at least one extractable substance, and a solids material comprising the comminuted de-juiced plant material; and
drying the solids material to make a dried comminuted material.

11. The process of claim 10, wherein said separating step further comprises preheating said comminuted material before said drying step.

12. The process of claim 10, wherein said drying step comprises contacting the comminuted material with a gas, and wherein said process further comprises separating said gas from said dried comminuted material.

13. The process of claim 12, wherein said step of separating said air from said dried comminuted material comprises the steps of
screening a substantial amount of said dried comminuted de-juiced plant material from said gas.

14. The process of claim 13, further comprising scrubbing said gas after screening to reduce any contaminants therein.

15. The process of claim 9, wherein said de-juiced plant material is comminuted to a particle size of less than 20 mesh.

16. The process of claim 1, wherein said comminuting and contacting steps are done simultaneously.

17. The process of claim 1, wherein said organic material is derived from plant material selected from the group consisting of fruits, vegetables, sugar cane and fiber crops.

18. The process of claim 1, wherein said organic material is derived from oranges.

19. The process of claim 1, wherein the sugar content of the comminuted material is low enough to allow it to easily crumble.

20. The process of claim 1, wherein said comminuted material is food grade.

21. A process for the recovery of useful products from de-juiced oranges, comprising the steps of:
obtaining at least partially de-juiced oranges comprising at least one extractable substance selected from the group consisting of sugars and citrus oils;
comminuting the de-juiced oranges to produce comminuted de-juiced oranges, wherein said comminuted de-juiced oranges have a particle size of less than 1/16 inch;
contacting the comminuted de-juiced plant material with a liquid consisting essentially of water for a contact residence time sufficient to extract a substantial amount of the at least one extractable substance from the comminuted dejuiced plant material into the liquid, wherein said contact residence time is at least 5 minutes and wherein said liquid has a temperature of at least 150 F;
wherein said comminuting and contacting steps occur simultaneously;
filtering the extracted comminuted de-juiced oranges to produce a filtrate comprising said liquid and said at least one extractable substance, and a filter cake comprising the extracted comminuted de-juiced oranges;
drying the filter cake with a gas comprising air;
separating the dried filter cake from said gas comprising air to form an exhaust comprising said gas and a dry product comprising the extracted comminuted de-juiced oranges; and
scrubbing said exhaust, such that after said scrubbing said exhaust comprises less than 12% of d-limonene.
